(19) United States
(12) Patent Application Publication
(10) Pub. No.: US 2008/0289169 A1
(43) Pub. Date: Nov. 27, 2008

(54) METHOD AND APPARATUS FOR JOINING PLATES

(75) Inventor: Eugen Rapp, Berg (DE)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: TOX PRESSOTECHNIK GMBH & CO. KG, Weingarten (DE)

(21) Appl. No.: 12/126,359

(22) Filed: May 23, 2008

(30) Foreign Application Priority Data
May 25, 2007 (DE) 102007024738

(51) Int. Cl. B23P 11/00; B30B 1/08

(52) U.S. Cl. 29/432; 100/271

(57) ABSTRACT

An apparatus and method for joining the assembly components that allows for the adjustment of working stroke and press forces during operation in order to control the thickness of the resulting joint point.

### CROSS-REFERENCE TO RELATED PATENT APPLICATIONS

This patent application claims the benefit of German application DE 10 2007 024 738, filed, May 25, 2007

### FIELD OF THE INVENTION

This invention pertains to an apparatus and method for joining assembly components to a plate so as to form a joining point having a bottom of a predetermined thickness.

### BACKGROUND OF THE INVENTION

In the process described as joining to connect assembly components, a so-called joining point forms by localized forming and subsequent compressing of the components being joined together. This is accomplished by means of a punch and a die where under a mutually opposing press force applied between the punch and the die during one working stroke, an extremely solid positive connection is made between the components.

It is known in the art that the ascertainable bottom thickness resulting from the making of the so-called joint point serves as control measure for the quality assurance of the joint. During joining of sheet metals, the remaining bottom dimension can be ascertained through the final bottom thickness. During the joining of sheet metals with other components, such as rivets, bolts, nuts, etc., the remaining bottom dimension, which is predominantly measured in the center of the joint point, serves as a control measure for the quality of the joint point.

Monitoring of the joint quality is required for production. Currently, this monitoring is done manually through a so-called X-measuring stylus. This monitoring is, of course, time consuming and, therefore, is only done as a spot check. The quality of this type of monitoring depends greatly on the person taking the measurement, although it can also be performed automatically according to various processes.

It is also well known to determine the remaining bottom dimension of the joint point subsequent to the forming process through the use of a pressure sensor measuring the press force along with the use of a computer. As is disclosed in German patent DE 4331403, the actual values of the press force are compared by computer calculation with in the nominal values existing within the computer. In this process, comparison of the actual value of the press force measurement with the nominal value stored in the computer allows for the determination of the bottom thickness of the joint point only after the joint is made. As a result, this quality check is only a comparative check against a desired thickness.

German patent DE 103 27 886 A1 discloses another process for determining the bottom dimension of a joint point. In this process, the existing press force exerted during the joining process is registered and calculated with a measured position value of the working stroke, in order to calculate by means of an algorithm a remaining bottom thickness while also taking into consideration the deflection factor of the machine tool (clinching system). This process also results in only a comparative attainment of the dimension of the remaining bottom thickness of the joint point

It has also been suggested (DE 10 2007 033 153 A1 ) that, following the production of the joint point, to use the remaining bottom thickness of the joint point as ascertained by means of a measuring device as a quality characteristic in that in certain intervals an actual value of the bottom thickness of the joint point calculated by means of a measuring device on the machine tool should be compared with a nominal range of this joint point measured with a calibrated measuring device, while the machine itself will be calibrated through the calibrated measuring device and thus serves itself as measuring device for the remaining bottom thickness of the produced joint point. Here too, the evaluation, is made through a computer, which compares the actual with the nominal value, or recommends or makes a correction of the setting. In this case also it is a correction or determination of a quality defect with the joint point already existing, that is, the already existing joint result can no longer be affected prior to terminating the joining process, which is, producing the joint point.

### BRIEF SUMMARY OF THE INVENTION

The invention involves an apparatus and method for joining together assembly components as a result of the repeated registering or measuring, during a working cycle, of each working stroke, or the measurement of the relevant press force, at the point in time of the work cycle when the joining process is occurring, thereby actively effecting the remaining bottom thickness of the joint. Based on the measurements performed of the press force made possible by electrical means within short intervals in the instance of a only less farther traveled working stroke, the relevant remaining bottom thickness just ascertained through the working stroke can be calculated with the help of the computer and the program. The working stroke will then be terminated by the computer, as soon as the nominal desired remaining bottom thickness has been attained, thereby eliminating the need for a subsequent measurement at the joint point. Furthermore, an automatic quality check occurs, thus making it possible that the actual value reached of the remaining bottom thickness X of the joint point lies within a nominal tolerance area of the nominal value and, thus, is continuously controlled.

Another advantage of the invention is that the negative effects of surface conditions (e.g., dry, oily) touching components and fluctuations of sheet-metal thickness can be avoided. Furthermore, by controlling the joint process, markedly smaller tolerances of the remaining bottom dimension can be achieved. These smaller tolerances can lead to higher joint point stability

Finally, the invention allows for adjustments as a result of variations in sheet-metal thickness as well as changes in strength due to strain-hardening in certain areas of the sheet-metal. Furthermore, defects on the machine tool and especially tool wear will be detected, if not eliminated, so that no product defect occurs.

### BRIEF DESCRIPTION OF THE DRAWINGS

FIG. 1 is a view of a clinch tong such as may be used in accordance with an embodiment of the invention.

FIG. 2 is a sectional view of joint point created using an embodiment of the invention.

FIG. 3 is a diagram showing the tolerance limits of the joint point.

### DETAILED DESCRIPTION OF THE INVENTION

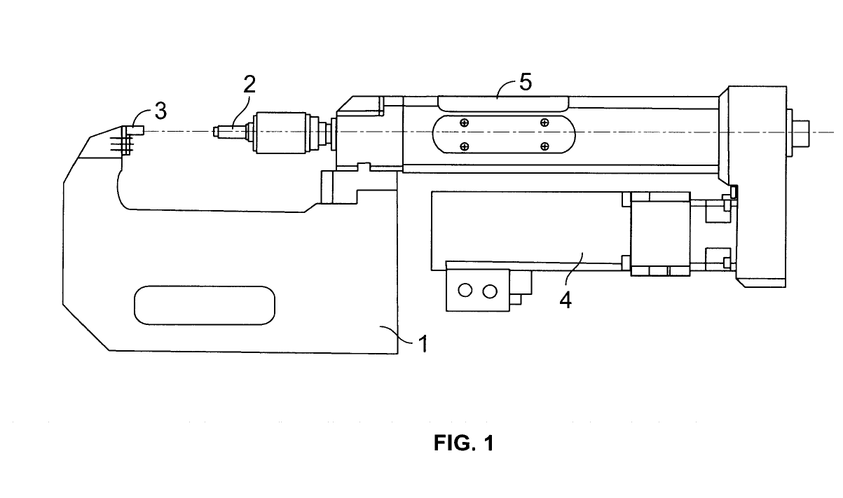

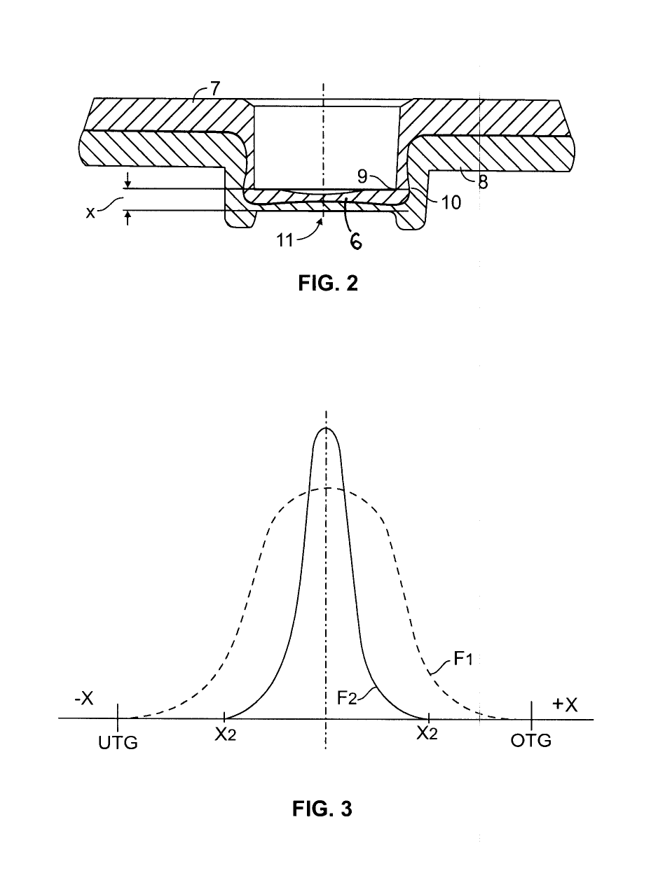

As shown in FIG. 1, a clinch tong 1 includes, on one side, a punch 2 which is coaxially aligned and opposite of a die 3 that is arranged on a second side displaced from the punch 2. The punch 2 is driven by motor 4 in the direction of die 3, whereby the press force generated thereby is registered through a measuring sensor 5. In an embodiment, the working stroke travels through a suitable displacement measuring system. As shown in FIG. 2, the working stroke and press force produce a joint 6 between a first and second assembly component.

As shown in FIG. 2, the joint point 6 produced in this manner between a first and second assembly component such as two sheets of metal 7 and 8 produces a certain interlock behind the drawn segment 9 of the sheet metal 7 and the drawn segment 10 of the sheet metal 8. Between the drawn segments 9 and 10 with their dovetail configuration, a residual bottom 11 is created, in the center of which a so-called remaining bottom dimension (i.e., bottom thickness) X occurs.

This remaining bottom dimension X is, as known, a criterion for the quality of the formed joint or the joint point 6, which is why this remaining bottom thickness is accordingly ascertained to evaluate the quality of the joint 6.

According to the present invention, the remaining bottom dimension X is determined using a computer (not shown) in which the process signals of working stroke and the press force of the sensor 5 are processed. It is important that the measured values or the process signals are not registered after termination of the production of the joint point 6, but during the working stroke, and, in fact, during several, very brief time intervals, so that it is possible to still make corrections during the production process of the joint point 6 through active control of the working stroke or press force. Based on the repeated measurement during a working stroke, the computer can quickly calculate the relevant current remaining bottom thickness X and actively regulate the thickness, taking into consideration the deflection of the tong 1 of the machine tool.

FIG. 3 shows the Gaussian distribution of the resulting remaining bottom thickness during a customary clinching (F1) and during clinching with a regulated remaining bottom thickness (F2) according to the invention.

When in operation, the working stroke is terminated or corrected when: (1) the registered actual value reaches or exceeds a nominal value preset in the computer; or (2) falls outside a tolerance limit of the nominal value. Thus, the working stroke is stopped or corrected during the course of the pressing operation. The invention allows for the determination of tolerance limits according to the individual outside conditions, such as material or desired strength. With the help of electrical, extremely fast working means (not shown), the required control of such functions, such as stopping or correcting of the working stroke, can be resolved without difficulty.

In an embodiment, a correction of the working stroke and press force occurs automatically through the computer. During the production of the joint point 6, the actual measured values may deviate from the nominal values for various reasons including, but not limited to, changes in the material to be joined, such as hardness or thickness, or other factors influencing the joint, such as lubricants.

In another embodiment, the computer program of the machine tool calculates recordable values originating during the joining process affecting the working force and the remaining bottom thickness. This means that with the help of the computer a correction to the machine tool itself may also be made, or, unforeseeable or undesirable stroke changes may be compensated or adjusted for.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method for joining a first and a second assembly component with one another to form a connection between the first and second assembly components, said connection having a predetermined thickness, the method comprised of:
aligning the first and second assembly components with one another;
applying a force via a press to a portion of both the first and the second assembly components;
measuring the working stroke of the press at multiple times during operation of the press;
measuring the force of the press at multiple times during operation;
transmitting the measures of working stroke and force to a computer;
using the computer to calculate the bottom thickness of the connection point based on the multiple measures of the working stroke and the force taken during a working cycle; and
using the calculated bottom thickness to control the operation of the press.

2. The method of claim 1 further comprising:
providing the computer with a present value for the stroke and the force of the press;
comparing the measured values of the stroke and the force of the press with the present value; and
adjusting at least one of the stroke and the force of the press if the measured value of one of the stroke and the force is not equal to the preset value.

3. The method of claim 2, further comprising shutting down the press if the measured value of one of the stroke and the force of the press deviates from the preset value by a predetermined tolerance limit.

4. The method of claim 2, further comprising executing one of a deviation and correcting calibration resulting from force changes depended on a space between a punch and a die on the press, said calibrations based on measurements recorded by the computer.

5. The method of claim 1, wherein the working stroke and press force needed to join the first and the second assembly components together at a predetermined thickness are calculated by a computer.

6. A press machine for joining a first and a second assembly component together so as to form a joined portion having a bottom of a predetermined thickness, said press comprised of:
a frame defining an opening having a first end capable of withstanding a force supplied by a press; and
an electric drive mechanism electrically connected to the press, said electric drive mechanism capable of calculating the thickness of the joined portion based on the force supplied by the press.
